(19) United States
(12) Patent Application Publication
(10) Pub. No.: US 2011/0038503 A1
(43) Pub. Date: Feb. 17, 2011

(54) EARPHONE

(75) Inventor: Bill Yang, Taipei City (TW)

Correspondence Address: J C PATENTS, 4 VENTURE, SUITE 250, IRVINE, CA, 92618, US

(73) Assignee: COTRON CORPORATION, Taipei City (TW)

(21) Appl. No.: 12/556,042

(22) Filed: Sep. 9, 2009

(30) Foreign Application Priority Data
Aug. 12, 2009 (TW) 98127117

(51) Int. Cl. H04R 1/00

(52) U.S. Cl. 381/380

(57) ABSTRACT

An earphone including a housing, a moving coil speaker, and a balance armature speaker is provided. The housing has an accommodating space and a single sound conducting channel connected to the accommodating space. The moving coil speaker and the balance armature speaker are disposed in the accommodating space of the housing, and sounds generated by the moving coil speaker and the balance armature speaker are output together through the single sound conducting channel. The earphone is characterized by soft bass from the moving coil speaker and a smooth frequency response curve from the balance armature speaker.

### CROSS-REFERENCE TO RELATED APPLICATION

This application claims the priority benefit of Taiwan application serial no. 98127117, filed Aug. 12, 2009. The entirety of the above-mentioned patent application is hereby incorporated by reference herein and made a part of specification.

### BACKGROUND OF THE INVENTION

1. Field of the Invention

The present invention generally relates to an earphone, in particular, to an earphone with a better sound quality.

2. Description of Related Art

With the progress of technology, electronic products are developed in the trend of being light, handy, and minimized, and people can use mini electronic products such as radios and walkmans at anywhere and anytime. Moreover, personal digital products become more and more popular, for example, common MP3 walkmans, mobile phones, personal digital assistances (PDA), or notebooks are especially indispensable in daily life. In addition, mobile phones having the functions of radios and MP3 have already emerged.

Regardless of the types of electronic products, the earphone has become a necessary accessory for electronic products, so that users can listen to audio information provided by the electronic products without disturbing others. Further, the earphone also enables the listeners to enjoy desirable audio transmission, and listen to and understand the audio contents clearly, thereby avoiding unclearness of voices transmitted in the air. Particularly, the users listening to the audio information may not be disturbed when moving, for example, exercising, driving, or doing intense activities, or in a noisy environment.

The conventional earphones generally use a moving coil speaker, which is characterized by soft sound quality, but has a non-smooth frequency response curve. Another type of earphone uses a balance armature speaker, which is characterized by a smooth but unnatural frequency response curve.

### SUMMARY OF THE INVENTION

Accordingly, the present invention is directed to an earphone, which provides an excellent and smooth frequency response curve to solve the problem of undesirable sound quality.

The earphone of the present invention includes a first housing, a moving coil speaker, and a balance armature speaker. The moving coil speaker and the balance armature speaker are disposed in an accommodating space of the first housing.

In an embodiment of the earphone of the present invention, the moving coil speaker includes a second housing, a speaker vibration system, and a magnetic loop. The speaker vibration system and the magnetic loop are disposed in a second accommodating space of the second housing. Further, the speaker vibration system includes, for example, a vibrating membrane and a coil disposed on the vibrating membrane. The magnetic loop includes, for example, a magnet and a polepiece. The moving coil speaker further includes a dust filter disposed at an opening of the second housing. Moreover, the moving coil speaker further includes a circuit board disposed outside the second housing.

In an embodiment of the earphone of the present invention, the balance armature speaker includes a second housing, a sounding assembly, a driving assembly, and a driving rod. The sounding assembly and the driving assembly are disposed in a second accommodating space of the second housing. Two ends of the driving rod are respectively connected to the sounding assembly and the driving assembly. Further, the sounding assembly includes, for example, a frame and a vibrating membrane. The frame is fixed to the second housing. The vibrating membrane is disposed on the frame. One end of the driving rod is connected to the vibrating membrane. Moreover, the driving assembly includes, for example, an armature, a coil, and a set of magnets. The armature is disposed in the second housing. The coil is disposed at the armature. The set of magnets are disposed at two sides of a free end of the armature. The other end of the driving rod is connected to the armature.

In an embodiment of the earphone of the present invention, the earphone further includes an ear cushion disposed at an opening of the first housing.

In view of the above, the earphone of the present invention is characterized by soft sound quality from the moving coil speaker and a smooth frequency response curve from the balance armature speaker.

In order to make the features and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of an earphone according to an embodiment of the present invention.

FIG. 2 is a cross-sectional view of a moving coil speaker in FIG. 1.

FIG. 3 is a cross-sectional view of a balance armature speaker in FIG. 1.

FIG. 4 is a comparison diagram of frequency response curves between the earphone in FIG. 1 and the conventional earphones.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

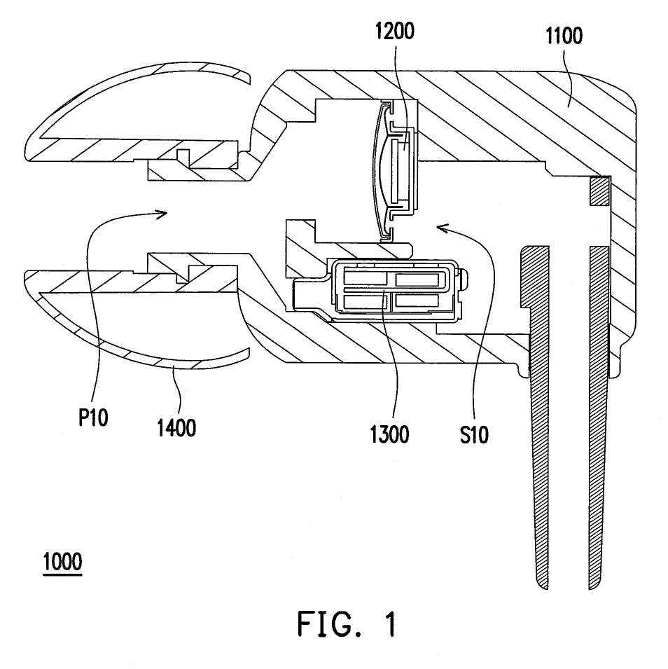

FIG. 1 is a cross-sectional view of an earphone according to an embodiment of the present invention. Referring to FIG. 1, the earphone 1000 of this embodiment includes a housing 1100, a moving coil speaker 1200, and a balance armature speaker 1300. The moving coil speaker 1200 and the balance armature speaker 1300 are disposed in an accommodating space S10 of the housing 1100. According to the construction of the earphone 1000 of this embodiment, it can be known that, a single earphone 1000 is disposed with at least one moving coil speaker 1200 and at least one balance armature speaker 1300. As such, the earphone 1000 is not only characterized by soft sound quality, but also by a smooth frequency response curve, thereby achieving a better sound quality. Additionally, the earphone 1000 of this embodiment further includes an ear cushion 1400 disposed at an opening P10 of the housing 1100.

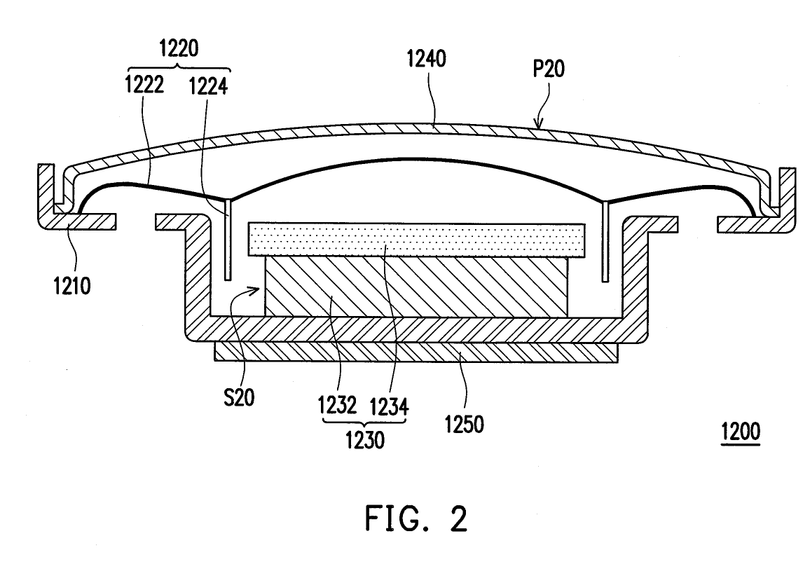

FIG. 2 is a cross-sectional view of the moving coil speaker in FIG. 1. Referring to FIG. 2, the moving coil speaker 1200 includes a housing 1210, a speaker vibration system 1220, and a magnetic loop 1230. The speaker vibration system 1220 and the magnetic loop 1230 are disposed in an accommodating space S20 of the housing 1210. The speaker vibration system 1220 includes, for example, a vibrating membrane 1222 and a coil 1224. The vibrating membrane 1222 of this embodiment is fixed to the housing 1210 by its periphery, and the coil 1224 is disposed on a lower surface of the vibrating membrane 1222. Further, the magnetic loop 1230 includes, for example, a magnet 1232 and a polepiece 1234. When the coil 1224 generates a variation in a magnetic field due to a change of an input electrical signal, the magnetic field of the coil 1224 interacts with a magnetic field of the magnet 1232 to move the coil 1224, thereby driving the vibrating membrane 1222 to vibrate to make a sound. In addition, the moving coil speaker 1200 further includes a dust filter 1240 disposed at an opening P20 of the housing 1210. The moving coil speaker 1200 also includes a circuit board 1250 disposed outside the housing 1210. Two ends of the coil 1224 are electrically connected to the circuit board 1250.

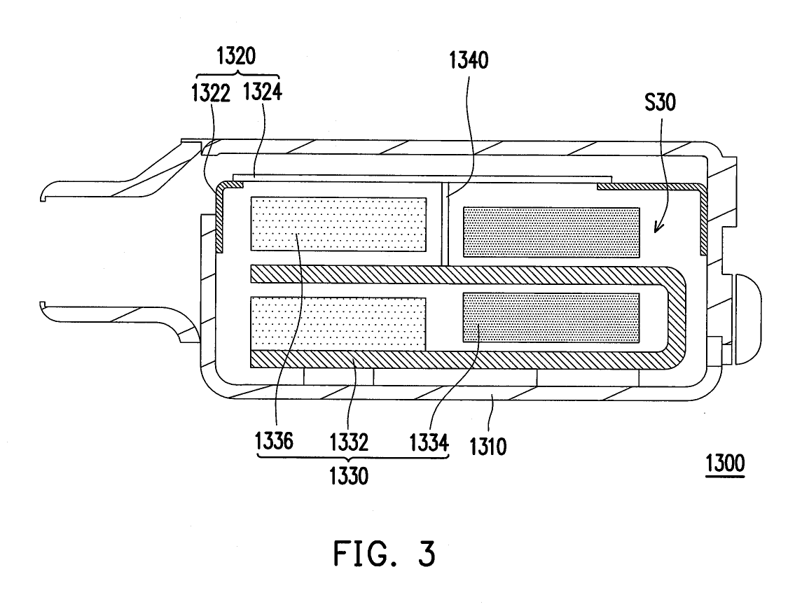

FIG. 3 is a cross-sectional view of the balance armature speaker in FIG. 1. Referring to FIG. 3, the balance armature speaker 1300 of this embodiment includes a housing 1310, a sounding assembly 1320, a driving assembly 1330, and a driving rod 1340. The sounding assembly 1320 and the driving assembly 1330 are disposed in an accommodating space S30 of the housing 1310. Two ends of the driving rod 1340 are respectively connected to the sounding assembly 1320 and the driving assembly 1330. The sounding assembly 1320 includes, for example, a frame 1322 and a vibrating membrane 1324. The frame 1322 is fixed to the housing 1310. The vibrating membrane 1324 is disposed on the frame 1322. The driving assembly 1330 includes, for example, an armature 1332, a coil 1334, and a set of magnets 1336. The armature 1332 is disposed in the housing 1310. The coil 1334 is disposed at the armature 1332. The set of magnets 1336 are disposed at two sides of a free end of the armature 1332. One end of the driving rod 1340 is connected to the vibrating membrane 1324. The other end of the driving rod 1340 is connected to the armature 1332. When the coil 1334 generates a variation in a magnetic field due to a change of an input electrical signal, an induced magnetic field of the armature 1332 varies accordingly. Due to interactions between the induced magnetic field of the armature 1332 and the magnetic field of the magnet 1336, a portion of the armature 1332 located between the two magnets 1336 repeatedly vibrates up and down, thereby driving the vibrating membrane 1324 to vibrate via the driving rod 1340 to make a sound.

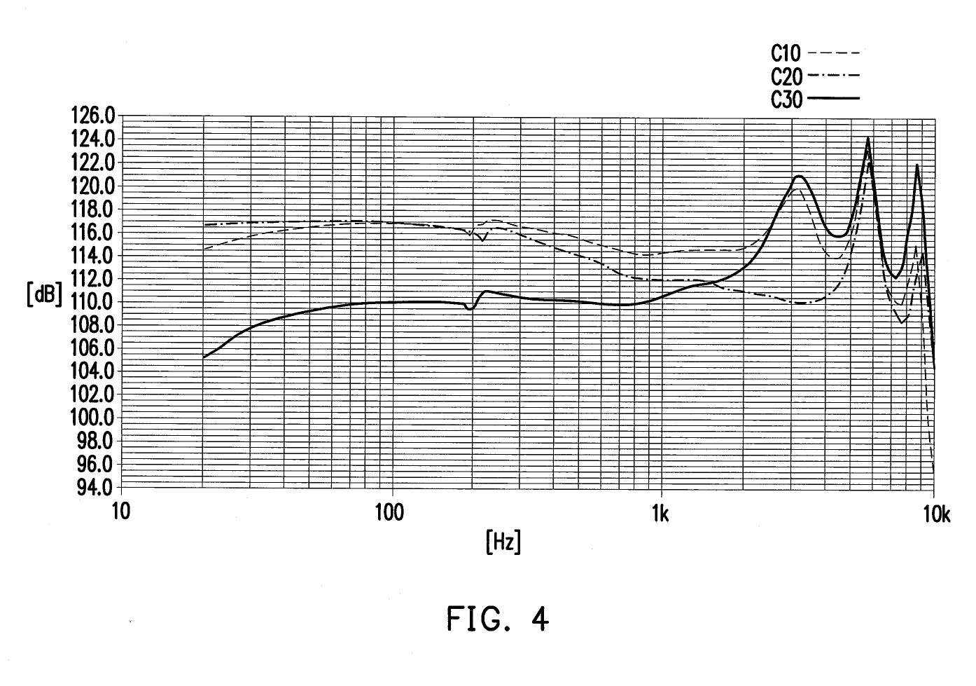

FIG. 4 is a comparison diagram of frequency response curves between the earphone in FIG. 1 and the conventional earphones. Referring to FIG. 4, a curve C10 represents a frequency response curve of the earphone 1000 in FIG. 1, in which the earphone 1000 includes the moving coil speaker 1200 and the balance armature speaker 1300. A curve C20 represents a frequency response curve of the earphone only having a moving coil speaker. A curve C30 represents a frequency response curve of the earphone only having a balance armature speaker. It can be seen from the curve C20 that, the earphone only having the moving coil speaker has a non-smooth frequency response curve, and it can be seen from the curve C30 that, the earphone only having the balance armature speaker has a smooth but unnatural frequency response curve. The curve C10 shows that the earphone 1000 in FIG. 1 is not only characterized by soft sound quality, but also by a smooth frequency response curve, thereby achieving a better sound quality.

In view of the above, the earphone of the present invention is provided with both the moving coil speaker and the balance armature speaker, so that the earphone is characterized by soft sound quality from the moving coil speaker and a smooth frequency response curve from the balance armature speaker, thereby achieving a better sound quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An earphone, comprising:
a first housing, provided with a first accommodating space and a single sound conducting channel;
a moving coil speaker, disposed in the first accommodating space; and
a balance armature speaker, disposed in the first accommodating space, wherein sounds generated by the moving coil speaker and the balance armature speaker are output together through the single sound conducting channel.

2. The earphone according to claim 1, wherein the moving coil speaker comprises:
a second housing, provided with a second accommodating space;
a speaker vibration system, disposed in the second accommodating space; and
a magnetic loop, disposed in the second accommodating space.

3. The earphone according to claim 2, wherein the speaker vibration system comprises a vibrating membrane and a coil disposed on the vibrating membrane.

4. The earphone according to claim 2, wherein the magnetic loop comprises a magnet and a polepiece.

5. The earphone according to claim 2, wherein the moving coil speaker further comprises a dust filter disposed at an opening of the second housing.

6. The earphone according to claim 2, wherein the moving coil speaker further comprises a circuit board disposed outside the second housing.

7. The earphone according to claim 1, wherein the balance armature speaker comprises:
a second housing, provided with a second accommodating space;
a sounding assembly, disposed in the second accommodating space;
a driving assembly, disposed in the second accommodating space; and
a driving rod, with two ends respectively connected to the sounding assembly and the driving assembly.

8. The earphone according to claim 7, wherein the sounding assembly comprises:
a frame, fixed to the second housing; and
a vibrating membrane, disposed on the frame, wherein one end of the driving rod is connected to the vibrating membrane.

9. The earphone according to claim 7, wherein the driving assembly comprises:
an armature, disposed in the second housing;
a coil, disposed in the armature; and
a set of magnets, disposed at two sides of a free end of the armature, wherein one end of the driving rod is connected to the armature.

10. The earphone according to claim 1, further comprising an ear cushion, disposed outside the single sound conducting channel of the first housing.
